(19) United States
(12) Patent Application Publication
(10) Pub. No.: US 2010/0232079 A1
(43) Pub. Date: Sep. 16, 2010

(54) SMALL AREA IO CIRCUIT

(75) Inventors: Chih Hung WU, Hsinchu (TW); Hung-Yi Chang, Hsinchu (TW); Kuo-Chung Hung, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: FARADAY TECHNOLOGY CORPORATION, Hsinchu (TW)

(21) Appl. No.: 12/635,172

(22) Filed: Dec. 10, 2009

(30) Foreign Application Priority Data
Mar. 12, 2009 (TW) 098108041

(51) Int. Cl. H02H 9/00

(52) U.S. Cl. 361/56

(57) ABSTRACT

A small area IO circuit is provided. The IO circuit has one or more parallel circuit unit(s) and an ESD protector set between a core circuit/pre-driver and an IO pad. Each circuit unit includes an off-chip driver and an output resistor, wherein the ESD protector protects ESD event occurred at the IO pad, and the resistor in each circuit unit acts as an ESD block circuit to block ESD current from corresponding off-chip driver. Therefore, transistors in each off-chip driver do not have to be restricted by strict ESD design rules, such that at least a transistor of the off-chip driver(s) is implemented in a single finger layout to lower equivalent capacitance of the off-chip driver(s), and layout areas of the off-chip driver(s) as well as the whole IO circuit can be reduced to achieve a small area IO circuit.

### FIELD OF THE INVENTION

The present invention relates to a small area IO circuit, and more particularly, to a small area IO circuit with resistor(s) for blocking ESD path such that layout areas of off-chip driver(s) as well as whole IO circuit can be effectively reduced.

### BACKGROUND OF THE INVENTION

Chips, Dice and/or ICs (Integrated Circuit) construct the most important hardware basis of modern information society. To make chips (dice and/or ICs) more prevailing, how to increase chip integration and reduce chip area (layout area) have become key issues of modern chip design, manufacturing and development.

As known by those ordinary skilled in the art, a chip is equipped with IO (Input/Output) circuits for exchanging signals with other circuits external to the chip. Please refer to FIG. 1 which depicts an original embodiment of an IO circuit 10. Working with a pre-driver 12, the IO circuit 10 has an off-chip driver 14. Signal outputted from an internal core circuit of the chip is transmitted to the off-chip driver 14 through the pre-driver 12, then the off-chip driver 14 can drive corresponding signal to an IO pad 16, such that signal of the core circuit can be sent to other circuits external to the chip. As shown in FIG. 1, the off-chip driver 14, operating between voltage levels Vdd and Vss, is constructed by an n-channel MOS (Metal-Oxide-Semiconductor) transistor Mn0 and a p-channel MOS transistor Mp0.

Because IO circuit 10 has to drive other circuits external to the chip (e.g., off-chip circuits like other chips and printed circuit boards), it must have strong signal driving strength. To provide sufficient signal driving strength, the transistors Mp0 and Mn0 occupy large layout area with wide channel width for enhancing driving strength. On the other hand, the IO circuit also needs ESD (Electro-Static Discharge) protection ability since the IO circuit is an interface to external environment and is vulnerable to ESD events. In the embodiment of FIG. 1, the off-chip driver 14 directly connects to the IO pad 16 as the off-chip driver 14 itself has to perform ESD protection also. Generally speaking, when ESD event occurs at the IO pad 16, a parasitical npn bipolar junction transistor works as an ESD path between drain and source of the n-channel MOS transistor Mn0, then ESD current is guided to the end of voltage level Vss for protecting the core circuit of the chip.

However, because the off-chip driver 14 itself needs to implement ESD protection also, layouts of transistors Mn0 and Mp0 must follow strict ESD design rules. For example, transistors Mn0 and Mp0 must have enough channel width to tolerate high current during ESD. In fact, transistor widths (sizes and/or dimensions) required by the ESD design rules are usually larger than those required by driving strength. In other words, in the circuit architecture shown in FIG. 1, layout areas of the off-chip driver 14 and therefore the whole IO circuit 10 will be dominated by the ESD design rules; as longer dimensions and larger areas are required by the ESD design rules, layout area of the IO circuit 10 can not be effectively reduced, even though the dimensions of the transistors Mn0 and Mp0 have far exceeded those required by the driving strength of the off-chip driver 14.

### SUMMARY OF THE INVENTION

It is therefore one of the objectives of the present invention to provide a small area IO circuit (e.g., an IO cell) which adopts an ESD protection circuit for ESD protection as well as ESD block circuit(s) formed by resistor(s) for substantially prevent ESD current from entering off-chip drivers, thus off-chip drivers of the invention are allowed to be free (released) from certain design rule restrictions (e.g., ESD design rules), and disadvantages of previously discussed embodiment that areas of off-chip drivers can not be reduced due to ESD design rules can then be avoided. With freed ESD design rules, at least a transistor in each off-chip driver of the invention can be implemented with single finger layout, therefore equivalent capacitance of each off-chip driver is reduced to achieve faster speed, lower switching power for signal transition, and smaller total area of the whole IO circuit. On the other hand, to prevent possible impact on driving strength and signal quality of off-chip drivers due to additional resistor(s), a plurality of combinations of resistors/off-chip drivers can be shunt to reduce potential side effect on driving strength and signal quality.

While off-chip driver of the invention is free from ESD design rules, layout of off-chip drive can be free from, for example, either design rule (restriction) of total finger width and/or contact to poly spacing. Off-chip drivers under these design rule restrictions usually suffer from extended dimensions, so their layout areas can not be reduced. With the restrictions effectively loosened by adopting technique of the invention, layout areas of off-chip drivers in the invention can be well reduced.

In an embodiment of the invention, an IO circuit (such as an IO cell) of the invention includes an IO pad for coupling to circuits external to the chip, an ESD protection circuit coupled to the IO pad, as well as one or more circuit units shunt between a pre-driver and the ESD protection circuit. The ESD protection circuit has a connection end and the pre-driver has a signal end. Each of the circuit unit included a driver (e.g., an off-chip driver) and an ESD block circuit. Each circuit unit has a first end and a second end respectively coupled to the signal end and the connection end.

In each unit circuit, the driver coupled to the signal end through the first end for driving signal transmitted from the signal end; the ESD block circuit is coupled between the driver and the second end. When ESD events occur at the IO pad, the ESD block circuit of each circuit unit can substantially prevent ESD current from entering (conducting to) the driver of each circuit unit through the connection end. Therefore, (off-chip) drivers of the invention are loosened from responsibility and functionality of ESD protection, and layout of the drivers can be free from ESD design rules which include (but not limited to) restrictions on either total finger width and/or contact to poly spacing. Also, at least a transistor in each of the driver can then be implemented with a single finger layout for reducing equivalent capacitance of each off-chip driver to gain faster speed and lower switch power dissipation.

Working with ESD block circuit(s), the ESD protection circuit performs ESD protection by forming (conducting) ESD path during ESD events. In an embodiment, the ESD protection circuit includes at least a diode or a Zener diode, each diode coupled between a corresponding voltage level (e.g., Vdd or Vss) and the IO pad through the connection end. When ESD event occurs at the IO pad, at least a diode conducts for guiding ESD current to the corresponding end of voltage level, such that ESD protection can be achieved.

In an embodiment of the invention, each driver of each circuit unit includes an n-channel MOS transistor and a p-channel MOS transistor, and the ESD block circuit is implemented with a resistor (e.g., an output end resistor); resistance of the resistor can be determined according to (but not limited to) factors such as breakdown voltage of transistor (e.g., the n-channel MOS transistor), and expected current of ESD events, so ESD path from the IO pad to the driver can be effectively blocked during ESD events. Generally speaking, with sufficient resistance, a voltage drop across two ends of the ESD block circuit (e.g., a resistor) will be larger enough to suppress voltage across drain/source of the n-channel MOS transistor, such that ESD path formed by breakdown conduction between drain/source of the n-channel MOS transistor can be prevented.

For managing possible impact on driving strength and signal quality of off-chip drivers caused by additional resistors in the ESD block circuits, a plurality of circuit units with combinations of resistors/off-chip drivers can be shunt to reduce potential degrading of driving strength and signal quality.

Because the invention changes to adopt an additional ESD protection circuit for ESD protection and ESD block circuits for blocking ESD paths to the off-chip drivers, design rule restrictions for off-chip driver, such as at least one of the following restrictions: total finger width and contact to poly spacing, can be loosened or freed, and the transistors of a same channel type in off-chip drivers can be implemented with single finger layout to reduce equivalent (parasitic) capacitance of the off-chip drivers and to gain faster speed and less switching power. Furthermore, even though the IO circuit of the invention includes an additional ESD protection circuit and plural shunt combinations of ESD block circuits (e.g., resistors) and off-chip drivers, total area of the whole IO circuit can be well reduced to implement a small area IO circuit.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates an embodiment of an original IO circuit;

FIG. 2 illustrates an IO circuit according to an embodiment of the present invention;

FIG. 3 illustrates an IO circuit according to another embodiment of the present invention;

FIG. 4 compares an original layout and an exemplary layout according to the invention for implementing n-channel MOS transistor and related portions of IO circuit;

FIG. 5 compares an original layout and an exemplary layout according to the invention for implementing p-channel MOS transistor and related portions of IO circuit;

FIG. 6 demonstrates a preferred embodiment of the invention for implementing n-channel MOS transistor and related portions in IO circuits shown in FIG. 2 and FIG. 3; and

FIG. 7 illustrates an IO circuit according to still another embodiment of the present invention.

### DETAILED DESCRIPTION OF THE PREFERRED EMBODIMENT

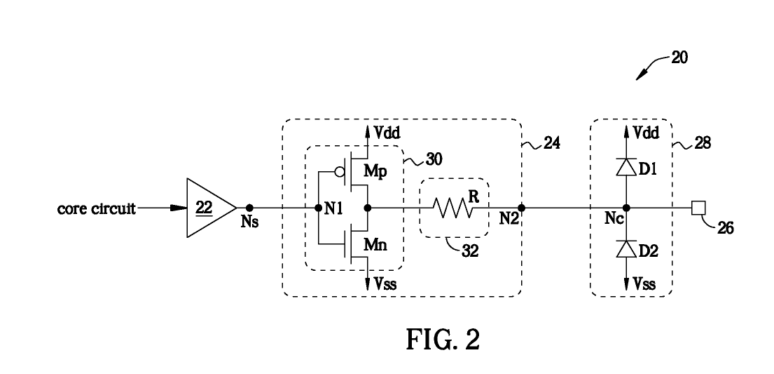

Please refer to FIG. 2, which shows an IO circuit 20 according to a first embodiment of the invention. The IO circuit 20 operates between voltage levels Vdd (e.g., power) and Vss (e.g., ground), and includes an IO pad 26, an ESD protection circuit 28 and a unit circuit 24. The IO circuit 20 locates in a chip for driving other circuit(s) (chip(s) and/or PCB) external to the chip through the IO pad 26 which is coupled to the external circuit(s). The ESD protection circuit 28 coupled to the IO pad 26 through a node Nc which can be considered as a connection end. Working with the circuit unit 24, a pre-driver 22 has a signal end at a node Ns. On the other hand, nodes N1 and N2 of unit circuit 24 can be respectively considered as a first end and a second end, and they are coupled to the signal end (node Ns) and the connection end (node Nc) respectively. The circuit unit 24 includes a driver 30 (e.g., an off-chip driver) and an ESD block circuit 32. Signal outputted from an internal core circuit of the chip is transmitted to the circuit unit 24 through the pre-driver 22, so the circuit unit 24 can drive a corresponding output to the IO pad 26 through nodes N2 and Nc, then signal of the core circuit can be transmitted to circuit(s) external to the chip.

In the circuit unit 24, the driver 30 coupled to the node N1 (first end) through the node Ns (signal end) can drive signal according to that received from the signal end. The ESD block circuit 32 is coupled between the driver 30 and the node N2 (second end). When ESD event occurs at the IO pad 26, the ESD block circuit 32 is capable of substantially preventing ESD current from entering the driver 30/unit circuit 24 through the nodes Nc and N2.

With the ESD block circuit 32 of the circuit unit 24 for blocking ESD path entering the driver 30, ESD path is instead conducted by the ESD protection circuit 28 for ESD protection. As an embodiment shown in FIG. 2, the ESD protection circuit 28 includes diodes D1 and D2; the diode D1 is coupled between voltage level Vdd and the node Nc, and the diode D2 is coupled between the node Nc and voltage level Vss. When ESD event occurs, at least a diode of the diodes D1 and D2 will conduct to guide ESD current toward an end of one of the voltage levels for ESD protection. For example, the diode D1 can forward conducts for guiding ESD current to the end of voltage level Vdd. The diode D2 can reverse conducts (e.g., conducts by breakdown) for forming ESD path to the end of voltage level Vss. At least one of the diodes can also be a Zener diode.

The driver 30 (e.g., an off-chip driver) can be implemented with an n-channel MOS transistor Mn and a p-channel MOS transistor Mp, and the ESD block circuit 32 can be implemented with a resistor R. The transistor R is coupled between the node N2 and drains of transistors Mn and Mp, wherein its resistance can be determined (designed) by considering the factors including (but not limited to) breakdown voltage of transistor in the driver 30 (like the transistor Mn) and expected current of ESD events, such that ESD path will be effectively blocked during ESD events. Generally speaking, as long as the resistor R has sufficient resistance, the resistor R can provide enough cross voltage to reduce voltage between source/drain of the transistor Mn during ESD events for avoiding ESD path conducted by breakdown between source/drain of the transistor Mn. In an equivalent view, ESD current can be blocked from entering the circuit unit 24/dirver 30 by the ESD block circuit 32.

Because the invention changes to utilize an ESD protection circuit 28 for ESD protection and an ESD block circuit 24 for blocking ESD path to the off-chip driver 30, layout design rule restrictions for off-chip driver 30 can be loosened free from strict ESD design rules. In this way, layout areas of the driver 30, the circuit unit 24 as well as the whole IO circuit 20 can be effectively reduced. Also single finger layout is therefore allowed to be adopted for implementing transistor Mn and/or Mp in the driver 30, so equivalent capacitance and switching power for signal transition of the off-chip driver can be reduced, and speed of the driver 30 will increase. While releasing ESD design rule for the driver 30, for example, layout of driver 30 can be free from restrictions of total finger width and/or contact to poly spacing. Usually these restrictions require extended dimensions of the off-chip driver, so layout area of off-chip driver can be minimized. With techniques of the invention, however, layout area and dimensions of off-chip driver can be well reduced.

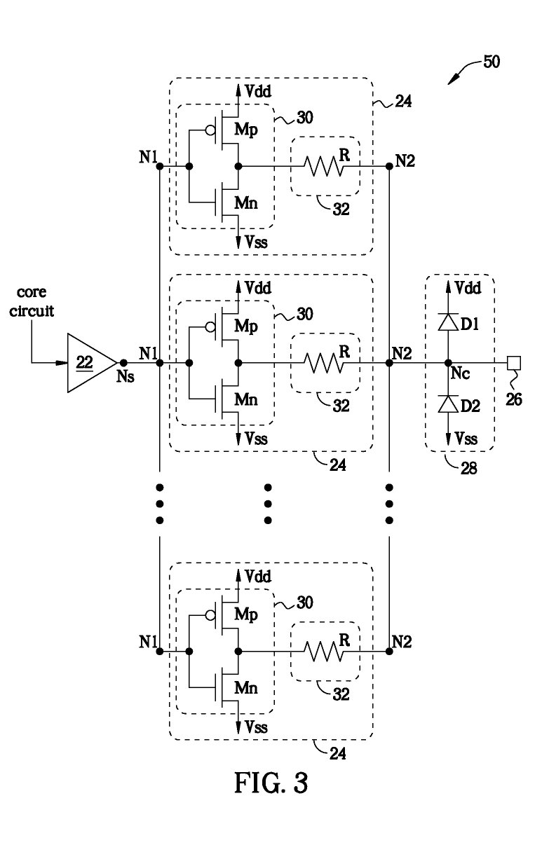

On the other hand, if resistance of the resistor R in the ESD block circuit 32 is large, signal output may be affected. To avoid possible degrading of driving strength and signal quality due to the resistor, a plurality of circuit unit 24 can further be shunt to reduce potential impact on driving strength and signal quality. As another embodiment of the invention, please refer to FIG. 3 which depicts an IO circuit 50 for such architecture.

Similar to the embodiment in FIG. 2, the IO circuit 50 in FIG. 3 is embedded in a chip for driving circuit(s) external to the chip. The IO circuit 50 operates between (regulated) voltage levels Vdd and Vss and includes an IO pad 26 and an ESD protection circuit 28. A difference between FIG. 2 and FIG. 3 is that the IO circuit 50 of FIG. 3 has a plurality of circuit units 24. The IO pad 26 works for coupled to circuit(s) external to the chip, the ESD protection circuit 28 is coupled to the IO pad 26 with a node Nc as a connection end. Working with the circuit units 24, a pre-driver 22 has a signal end at a node Ns. As a first end and a second end, nodes N1 and N2 of each circuit unit 24 are respectively coupled to the signal end (node Ns) and the connection end (node Nc), such that the plurality of parallel circuit units 24 are shunt between the nodes Ns and Nc.

Each circuit unit 24 in FIG. 3 also includes a driver (e.g., an off-chip driver) 30 and an ESD block circuit 32, similar to that shown in FIG. 2. Signal from a core circuit of the chip is transmitted to each circuit unit 24 by the pre-driver 22, and then the circuit units 24 drive corresponding output signals to the IO pad 26 through the nodes N2 and Nc, so the signal of the core circuit can be outputted to external circuit(s). When ESD events occur at the IO pad 26, the ESD block circuit 32, implemented by a resistor R in each of the circuit units 24, can substantially prevent ESD current from entering the driver 30 of each circuit unit 24 through the nodes Nc and N2.

Working with ESD block circuits 32 for blocking ESD path to the driver 30 in each circuit unit 24, the IO circuit 50 relies on the ESD protection circuit 28 for ESD protection by conducting ESD path during ESD events. The ESD protection circuit 28 operates in a way similar to the ESD protection circuit 28 of FIG. 2, so redundant details are omitted. In the embodiment of FIG. 2, when the driver 30 of the circuit unit 24 outputs current for signal driving, cross voltage built on the resistor R by the current may affect signal amplitude and quality on the IO pad 26. However, because a plurality of circuit units 24/drivers 30 are shunt in the embodiment of FIG. 3, total output current will be shared by the drivers 30; equivalently, resistance of the resistor R in each circuit unit 24 can be reduced to lower possible impact on signal output.

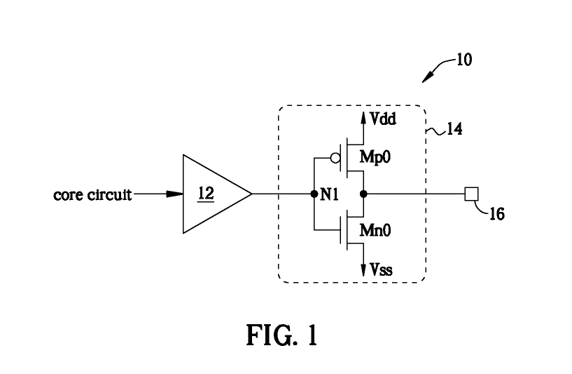

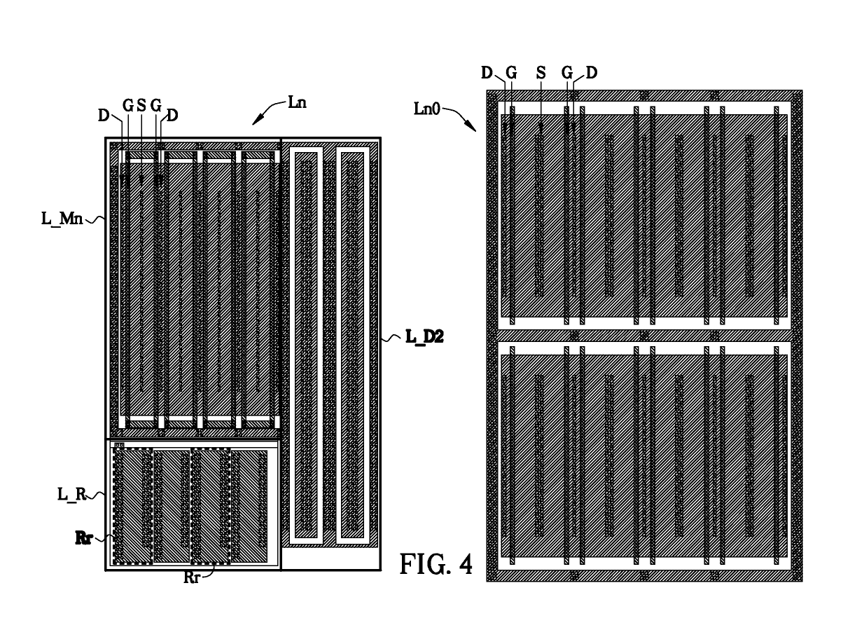

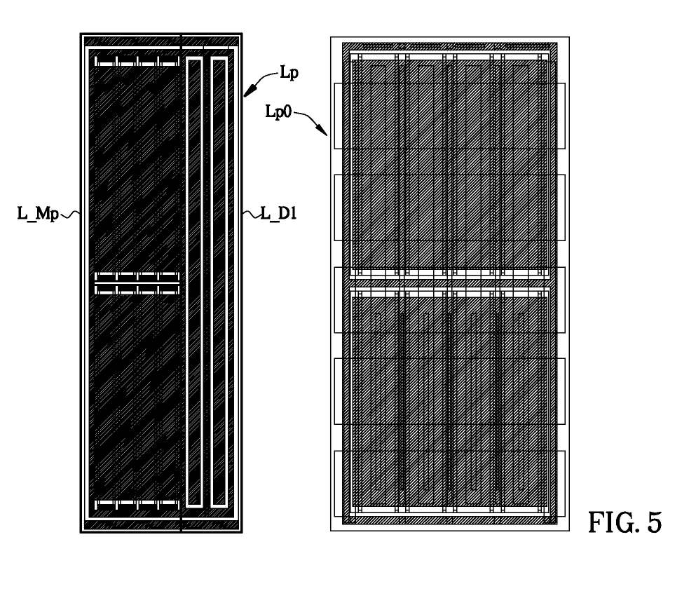

Similar to FIG. 2, the embodiment in FIG. 3 can loosen layout design rules on circuit units 24 and reduce layout area of each driver 30 because of a better ESD protection scheme of the invention, thus transistors of a same type of channel, e.g., transistor Mn (and/or Mp) of each driver 30 can be implemented with single finger layout to gain lowered equivalent capacitance, faster response speed and less switching power. In addition, owing to shunt architecture of plural circuit units 24 (and driver 30), possible impact on signal driving strength and signal quality can be lowered. In fact, as a better ESD protection arrangement is adopted in the invention, even though additional ESD protection circuit and plural shunt combinations of ESD block circuits/drivers are included in the IO circuit 50 of the invention, total layout area of the IO circuit 50 is smaller than that of FIG. 1. To further demonstrate area reducing of the invention, please refer to FIG. 4 and FIG. 5.

For n-channel MOS transistor and related portions of IO circuit, FIG. 4 compares layout dimensions and areas of an original embodiment according to FIG. 1 and a novel embodiment according to the invention, and FIG. 5 compares those for p-channel MOS transistor and other related portions of IO circuit. On the right side of FIG. 4, a layout Ln0 for n-channel MOS transistor Mn0 (FIG. 1) of the original embodiment is shown. On the other hand, a layout Ln illustrated on the left side of FIG. 4 implements the diode D2 and the plural (e.g., four) combinations of n-channel MOS transistors Mn and corresponding resistors R shown in the embodiment of FIG. 3. In the layout Ln, a layout L_D2 implements the diode D2 of the ESD protection circuit, four layouts Rr implements four resistors R for ESD block circuits, and a layout L_Mn implements transistors Mn in respective drivers 30 with gate, drain and source of each transistor Mn labeled as G, D and S in FIG. 4. In a general off-chip driver, distance (measured alone the channel length) between gate G and source S is set longer than that between gate G and drain D. However, as previously discussed, since the original embodiment of FIG. 1 relies on the driver itself for ESD protection, layout for transistors in the driver must follow strict ESD design rules, thus dimensions and area of the layout Ln0 can not be reduced; for example, the distance between gate G and source S can not be reduced. On the contrary, because a better ESD protection scheme is adopted in the invention, layout design rules for transistors in the driver can be loosened free from ESD design rules. With identical current driving strength, area of the layout Ln according to the invention is merely 56% of that of the layout LnO, wherein dimensions of the layout Ln and Ln0 are respectively 24 microns by 37 microns and 32 microns by 49 microns. In other words, even though the layout Ln of the invention includes portions of additional ESD protection circuit and ESD block circuits (resistors), its area sums to be smaller.

In FIG. 5, a layout Lp0 for implementing the p-channel MOS transistor Mp0 of FIG. 1 is shown on the right side, as a layout Lp of the invention shown on the left side implements p-channel MOS transistors Mp (FIG. 3) with a layout L_Mp and the diode D1 with a layout L_D 1. Similarly, under same driving strength, area of the layout Lp according to the invention (with dimensions 24 microns by 65 microns) can be reduced to 75% of that of the layout Lp0 (with dimensions 32 microns by 65 microns).

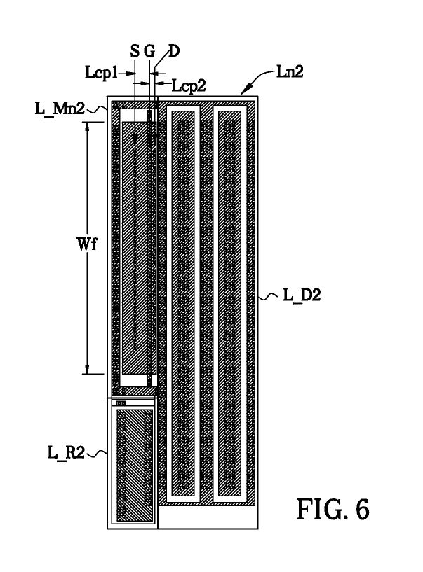

One of the key features of the invention is that the ESD design rules are released from layouts of the (off-chip) drivers, such that transistor(s) in each driver 30 can be implemented with single finger layout. Please refer to FIG. 6 for such embodiment, where a layout Ln2 implements the diode D2 (FIG. 2 and/or FIG. 3) and the n-channel MOS transistor Mn/resistor R in each of circuit units 24. As shown in FIG. 6, the diode D2 forms in a layout L_D2, the resistor(s) R can be implemented by layout L_R2, and transistor(s) Mn can be implemented in single finger layout L_Mn2 with gate, drain and source respectively labeled as G, D and S. In FIG. 6, the layout for transistor Mn shows a stripe shape with a single stripe gate G linearly distributed along a straight line to form a single finger, as there is no need to adopted comb-shaped multiple fingers of FIG. 4. The single finger layout reduces area and thus equivalent capacitance, increases speed and decreases switching power dissipation of the off-chip driver 30. Similar layout can also apply to transistor(s) Mp of the driver 30. While freeing driver layout restrictions from ESD design rules, for example, the layout L_Mn2 for transistor Mn can be free from design rule restriction of total finger width, and/or design rule restriction of contact to poly spacing. The total finger width can be understood by dimension Wf of FIG. 6, and the contact to poly spacing can be understood referring to dimensions Lcp1 and/or Lcp2. In the original embodiment, these dimensions must be set longer to some extend for following design rule restrictions, thus the layout area of the driver can not be minimized. With design rule restrictions loosened (or freed) by introducing techniques of the invention, layout area and dimensions of the driver(s) can then be well reduced.

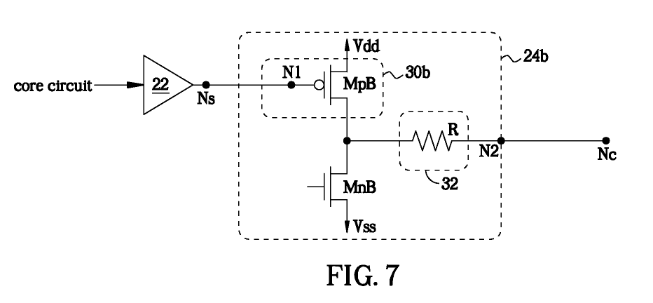

Please refer to FIG. 7 which depicts a driver 30b in a circuit unit 24b according to another embodiment of the invention. The circuit unit 24b includes an n-channel MOS transistor MnB, a p-channel transistor MpB and a resistor R as an ESD block circuit 32. In this embodiment of the invention, the single p-channel MOS transistor MpB functions as the off-chip driver 30b for receiving signal of a pre-driver 22 through a node N1 (a first end) and driving corresponding signal to a node N2 (a second end). The n-channel MOS transistor MnB functions as an active load with its gate biased in a predetermined way (not shown). Similar to the circuit unit 24 in FIG. 2 and FIG. 3, the circuit unit 24b in FIG. 7 can be coupled to the nodes Ns (the signal end) and Nc (the connection end) in FIG. 2 and FIG. 3 through the nodes N1 and N2, so the circuit unit 24b can be adopted in the circuit architecture of FIG. 2 and FIG. 3 for forming a complete IO circuit with the pre-driver 22 and the ESD protection circuit 28. Following the same principle, because the circuit unit 24b also includes built-in ESD block circuit 32, the transistor MpB of the driver 30b is free from restrictions of ESD design rules to gain reduced sizes and area. The transistor MpB can be implemented with single finger layout of small area as well.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An IO circuit in a chip for driving circuits external to the chip, wherein the IO circuit comprising:
an IO pad for coupling to circuits external to the chip;
an ESD protection circuit coupled to the IO pad, the ESD protection circuit having a connection end;
a signal end coupled to a pri-driver; and
at least a circuit unit, each circuit unit comprising:
a first end and a second end respectively coupled to the signal end and the connection end;
a driver coupled to the first end for driving signal transmitted from the signal end, and
an ESD block circuit coupled between the driver and the second end;
wherein when ESD event occurs at the IO pad, the ESD block circuit of each of the circuit unit substantially prevents ESD current from entering the driver of each of the circuit unit through the connection end.

2. The IO circuit of claim 1, wherein at least a transistor in each of the driver is implemented with a single finger layout.

3. The IO circuit of claim 1, wherein the ESD block circuit substantially prevent ESD current from entering the driver through the connection end of each of the circuit unit, such that layout of the driver is free from restriction of ESD design rules.

4. The IO circuit of claim 1, wherein the ESD block circuit substantially prevent ESD current from entering the driver through the connection end of each of the circuit unit, such that layout of the driver is free from design rule of total finger width.

5. The IO circuit of claim 1, wherein the ESD block circuit substantially prevent ESD current from entering the driver through the connection end of each of the circuit unit, such that layout of the driver is free from design rule of contact to poly spacing.

6. The IO circuit of claim 1, wherein the ESD block circuit is a resistor.

7. The IO circuit of claim 1 comprising a plurality of circuit units.

8. The IO circuit of claim 1, wherein each driver of each of the circuit unit comprises a transistor and the ESD block circuit comprises a resistor coupled between the transistor and the second end, wherein resistance of the resistor is determined according to breakdown voltage of the transistor and expected current of ESD events.

9. The IO circuit of claim 8, wherein the transistor is an n-channel MOS transistor or a p-channel MOS transistor.

10. The IO circuit of claim 1, wherein the ESD protection circuit comprises at least a diode or a Zener diode, each diode coupled between the connection end and a corresponding voltage level; wherein when ESD event occurs, at least a diode conducts to guide ESD current.

11. An IO circuit in a chip for driving circuits external to the chip, wherein the IO circuit comprising:
an IO pad for coupling to circuits external to the chip;
an ESD protection circuit coupled to the IO pad, the ESD protection circuit having a connection end;
a plurality of circuit units, each circuit unit comprising:
a first end and a second end respectively coupled to a same signal end and the connection end;
a driver coupled to the first end for driving signal transmitted from the signal end, and
an ESD block circuit coupled between the driver and the second end;
wherein when ESD event occurs at the IO pad, the ESD block circuit of each of the circuit unit substantially prevents ESD current from entering the driver of each of the circuit unit through the connection end.

12. The IO circuit of claim 11, wherein at least a transistor in each of the driver is implemented with a single finger layout.

13. The IO circuit of claim 11, wherein the ESD block circuit substantially prevent ESD current from entering the driver through the connection end of each of the circuit unit, such that layout of the driver is free from restriction of ESD design rules.

14. The IO circuit of claim 11, wherein the ESD block circuit substantially prevent ESD current from entering the driver through the connection end of each of the circuit unit, such that layout of the driver is free from design rule of total finger width.

15. The IO circuit of claim 11, wherein the ESD block circuit substantially prevent ESD current from entering the driver through the connection end of each of the circuit unit, such that layout of the driver is free from design rule of contact to poly spacing.

16. The IO circuit of claim 11, wherein each driver of each of the circuit unit comprises a transistor, and the ESD block circuit is coupled between the transistor and the second end.

17. The IO circuit of claim 16, wherein the ESD block circuit is a resistor with resistance determined according to breakdown voltage of the transistor and expected current of ESD events.

18. The IO circuit of claim 16, wherein the transistor is an n-channel MOS transistor or a p-channel MOS transistor.

19. The IO circuit of claim 11, wherein the ESD protection circuit comprises at least a diode or a Zener diode, each diode coupled between the connection end and a corresponding voltage level; wherein when ESD event occurs, at least a diode conducts to guide ESD current.
